(19) United States
(12) Patent Application Publication
(10) Pub. No.: US 2009/0210497 A1
(43) Pub. Date: Aug. 20, 2009

(54) SELECTIVE INSTANT MESSAGING (IM) NOTIFICATIONS BASED ON SENDER/RECEIVER RELATIONSHIPS

(75) Inventors: SEAN CALLANAN, CHURCHTOWN (IE); AL CHAKRA, APEX, NC (US); HUGH SMYTH, CLONTARF (IE); SMRITI TALWAR, CLONSILLA (IE)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/030,906

(22) Filed: Feb. 14, 2008

(51) Int. Cl. G06F 15/16

(52) U.S. Cl. 709/206

(57) ABSTRACT

The present invention presents a solution for prioritizing instant messaging (IM) communications based on sender/receiver relationships and for presenting selective notifications based upon the established priorities. The invention can include a data store, a message prioritization engine, and a client-side IM application. The data store can manage information describing relationships among people and recipient configurable IM prioritizing information. The message prioritization engine can determine a priority value for IM communications based upon the relationships and recipient configurable IM prioritizing information of the data store. The client-side IM application can receive IM messages that have an associated priority value established by the message prioritization engine. The client-side application can present an indicator of the priority value for associated IM messages within a user interface. In one embodiment, the information describing relationships used by the prioritization engine can be acquired from at least one social networking system.

### BACKGROUND OF THE INVENTION

The present invention relates to the field of instant messaging (IM) and, more particularly, to providing selective IM notifications based on send/receiver relationships.

Instant messaging (IM) applications are a cornerstone of social networking communities. IM applications allow for members of a social networking community to engage in conversations in real-time and over vast distances. As a member increases activity within the social network community, the more IM messages they receive. This increased amount of message traffic greatly reduces the user's ability to easily identify an order in which the messages should be answered. For example, a user may not recognize the name associated with a message and opt to answer another message first, unaware that the unrecognized name corresponds to a new coworker who is trying to request information.

Further, messages from unrecognized names can consume a user's time as the user tries to ascertain the commonality shared between themselves and the unrecognized user. The user profile associated with the unrecognized name can be examined for any obvious commonalities. However, since user profiles rely upon user-entered input to describe themselves and/or their interests, a commonality can often be hidden behind synonymous terms and/or colloquialisms.

For individuals active within one or more social networking systems, identifying which IM messages of a potentially large received volume should receive immediate attention is difficult if not impossible with conventionally available IM tools. The problem is further complicated as considerations leading to an importance of an IM can be highly situational. For example, an IM message from a spouse of a project team member received during work hours on a day a project specific milestone exists can be much more important than a message sent from the same spouse in a different context. In another example, an IM from an unknown individual who is to attend an event with a recipient and a common friend can be much more significant to the individual than a message sent from the same unknown individual normally.

### BRIEF SUMMARY OF THE INVENTION

One aspect of the present invention can include an instant messaging (IM) system that prioritizes messages and that presents different notifications for incoming IM communication attempts based upon the determined priority of the communication attempt. The system can include a data store, a message prioritization engine, and a client-side IM application. The data store can manage information describing relationships among people and recipient configurable IM prioritizing information. The message prioritization engine can determine a priority value for IM communications based upon the relationships and recipient configurable IM prioritizing information of the data store. The client-side IM application can receive IM messages that have an associated priority value established by the message prioritization engine. The client-side application can present an indicator of the priority value for associated IM messages within a user interface. In one embodiment, the information describing relationships used by the prioritization engine can be acquired from at least one social networking system.

Another aspect of the present invention can include a method, computer program code, and system for prioritizing Instant Messaging (IM) communications for notification presentation purposes. In the aspect, an IM communication initiating message can be received directly from a sender directed to a recipient. A relationship between the sender and recipient can be determined. In one embodiment, this determination can be based at least in part upon data gathered from a social networking system. A priority value can be calculated for the IM communication initiating message based upon the determined relationship. The priority value can be conveyed to the recipient along with the IM communication initiating message. Different notifications can be presented upon a recipient's device based upon the priority value, which permits the recipient to quickly ascertain a relative importance of incoming IM communication.

Still another aspect of the present invention can include a method for ascertaining an importance of incoming IM communication. In the method, an incoming IM communication can be received. A notification can be presented to a recipient of the incoming IM communication, which indicates a relative priority of the incoming IM communication. The relative priority can be calculated based upon a relationship between the recipient and an initiator of the incoming IM communication and/or based upon determined commonalities existing between the initiator and the recipient. The relationship and/or the commonalities can be based upon data acquired from at least one social networking system.

### BRIEF DESCRIPTION OF THE SEVERAL VIEWS OF THE DRAWINGS

FIG. 1 is a schematic diagram illustrating a system for prioritizing instant messaging (IM) messages and/or for presenting an IM recipient with priority based notifications for incoming IM attempts based on a determined relationship and/or a communication context existing between a sending user and a receiving user.

FIG. 2 shows a sample interface for a system that presents IM attempt notifications based upon relationships and/or commonalities existing between communicators.

FIG. 3 is a flow chart of a method for determining a relationship between an IM sender and a receiver and for presenting different notifications to the IM receiver indicative of a relative importance of an incoming IM communication.

### DETAILED DESCRIPTION OF THE INVENTION

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

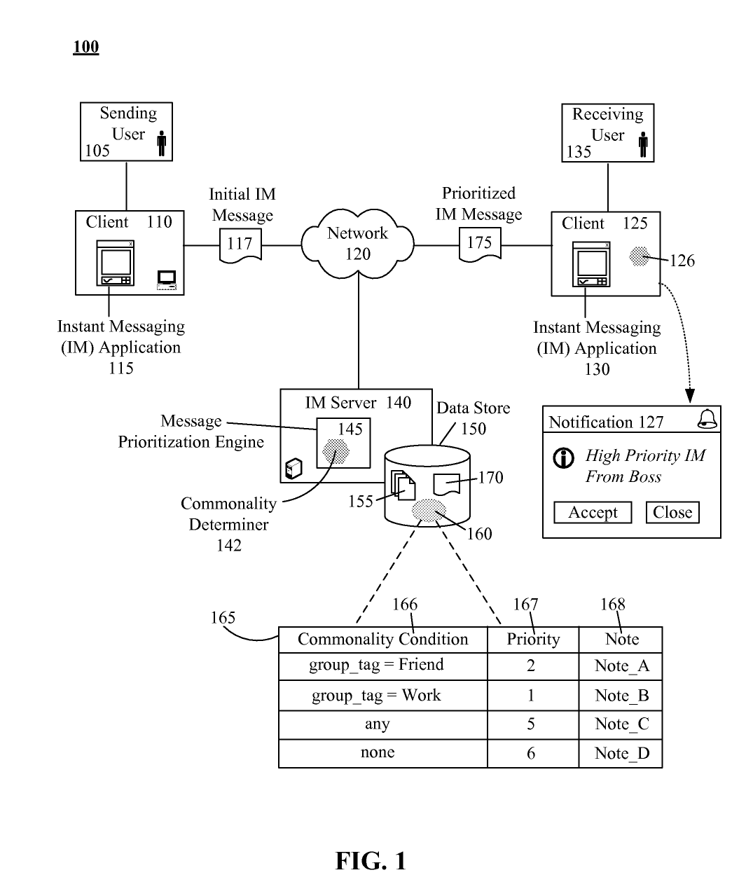

FIG. 1 is a schematic diagram illustrating a system 100 for prioritizing instant messaging (IM) messages 117 and/or for presenting an IM recipient with priority based notifications 127 for incoming IM attempts based on a determined relationship and/or a communication context existing between a sending user 105 and a receiving user 135. In one embodiment, the relationship can be determined based upon a relationship among the sender 105 and receiver 135 within a social network system. Additionally, a context of the IM communication attempt can be inferred based upon a commonality among the sender 105 and receiver 135 and an importance of that commonality at a time that the IM communication attempt occurs. The notifications 127 can be presented in accordance with recipient configurable settings. Priority determinations can also be based upon settings configured by an IM recipient 135.

As used herein, an IM communication can refer to an Internet Protocol (IP) based electronic communication that involves immediate correspondence between two or more users who are all online simultaneously. An IM communication can include a presence awareness aspect, where a set of communicators can be made aware of whether other communicators are available for IM communications. For example, many IM applications utilize a “buddy” list or contact list and provide an availability status next to each individual on the list. IM communications are not limited to text exchanges, but can also include file sharing capabilities, voice communication capabilities, video teleconferencing capabilities, remote desktop sharing capabilities and the like. For purposes of the present invention, chat communications that often are related to chat forums—public and private, and text messaging communications are to be considered IM communications.

A social network system can refer to a computing system that facilitates collaboration and/or interactions among a set of users having interdependencies and/or commonalities, such as shared values, visions, ideas, friends, kinship, dislikes, hobbies, political affiliations, religious affiliations, diseases, financial interests, and the like. User-to-user interconnections within a social networking system can be direct or indirect (e.g., through a set of shared friends). Social networking systems can include, but are not limited to, MYSPACE.COM, CLASSMATES.COM, FACEBOOK.COM, FLICKR.COM, PLAXO.COM, DODGEBALL.COM, FACEPARTY.COM, GATHER.COM, GUILDCAFE.COM, and the like.

In system 100, the initial IM message 117 can be sent by a sending user 105 utilizing an IM application 115 of client 110. The message 117 can be delivered over a network 120 to an instant messaging server 140. The server 140 can determine a priority for that the message 117, wherein the priority is defined for the receiving user 135 by a message prioritization engine 145. Programmatic logic of the prioritization engine 145 can base the priority upon a set of available data elements that include, but are not limited to, a user profile 155, prioritization settings 160, user specified tag data 170, message context data, and the like. The prioritized message 175 can be sent to IM application 130 of a client 125 used by the receiving user 135. An IM intake component 126 can detect the incoming message 175 and can present a suitable notification 127 based at least in part upon the priority established by engine 145. Different user configured settings can be established for the IM intake component 126.

The notification 127 can be visual (e.g., a pop-up window, a characteristic indicator, etc.), audible (e.g., a priority tone, a speech message indicating priority, etc.), and the like. Notification 127 can take many forms that can even be conveyed to devices external to the client 125 upon which an IM application resides. For example, in various embodiments, the notification 127 can include a fax message, an email message, a voice mail message, and the like. More extensive measures can be taken for higher priority messages (such as sending notifications to devices other then client 125) to ensure a receiving user 135 is informed of important IM attempts in a timely fashion. The notification 127 can be used by the receiving user 135 to quickly discern whether the user 135 wishes to accept/engage in an IM communication with user 105 using IM application 130.

The client devices 110 and 125 can be a variety of electronic devices capable of executing IM applications 115, 130. For example, the client devices 110, 125 can include, but are not limited to, a computer, an IM-enabled mobile phone, an IM-enabled personal data assistant (PDA), a laptop computer, and the like.

The IM applications 115 and 130 can be any software application capable of sending/receiving IM messages 115, 175. One or more of the IM applications 115, 130 can include code (e.g., executable code of the intake component 126, for example) able to perform different programmatic actions depending upon a priority of an incoming IM message 175.

The IM server 140 can represent a computing device configured for the delivery of IM messages 117 and 175 from a sending user 105 to a receiving user 135 over the network 120. The server 140 can represent a single stand-alone server or a set of distributed components interacting to perform the functions of an IM server 140. For example in one embodiment, engine 145 can be implemented as a Web service (or other program/service from a network element) provided as an enhancement to a conventional IM server 140 that otherwise lacks prioritization capabilities. In another embodiment, the functionality attributed to engine 145 can be implemented by client-side programs (executing in client 110 and/or 125). Additionally, the IM server 140 can include additional software components (not shown) for the performance and/or enhancement of this functionality. For example, the IM server 140 can include presence awareness functionality, forum establishment functionality, message format conversion capabilities, transcoding capabilities from one communication form to another (e.g., dynamically converting between input text input by a sender 105 to equivalent speech received by recipient 135), and the like.

Server 140 can access data stored within data store 150. The data store 150 can include user profiles 155, prioritization settings 160, and user-specified tag data 170. A user profile 155 can represent a collection of user-entered data elements that describe an individual user of the IM system. Examples of data elements contained within a user profile 155 can include a user's name, address, interests, hobbies, email address, and the like. The data elements contained in a user profile 155 can be tagged by a user to provide key word associations for catalog and query functions. These associations can be stored as user-specified tag data 170. Additionally, a relative importance and/or context of user tagged data 170 can be specified.

The prioritization settings 160 can represent associations between commonality conditions 166 and priorities 167, as shown in the sample table 165. The commonalities can be determined based upon social networking relationships. In one embodiment, a direct feed from one or more social networking sites and the data store 150 can exist, that that as social networking information changes, the commonalities can correspondingly change. The sample table 165 can determine other social networking derived data elements, such as a strength of relationship score and/or a strength of commonality 166 score, which can be utilized by the engine 145. Table 165 shows a rudimentary set of data elements from which a priority can be determined to illustrate a general concept. Accordingly, the scope of the invention is not to be interpreted as limited to the elements shown in table 165, but is intended to include any attribute/element derivable from a social networking system and/or user provided data.

In one embodiment, the prioritization engine 145 can construct notes 168 detailing specifics of a relationship between the user 105 and user 135 and/or indicating commonalities between users 105, 135. Any important characteristic used in calculating the priority 167 can be included in the notes 168 to assist the user 135 in determining an importance of an incoming IM communication 175. The notes 168 can optionally be presented within notification 127.

In one embodiment, the message prioritization engine 145 can include a commonality determiner 142. The commonality determiner 142 can be a software algorithm designed to evaluate the user and/or automatically defined commonality criteria 166 in order to determine a priority 167 for the received IM message 117. In order to evaluate the commonality conditions 166, the commonality determiner 142 can search through the user profiles 155 and user-specified tag data 170 associated with both the sending 105 and receiving 135 users. By doing so, the commonality determiner 142 can evaluate broader conditions such as “any” commonality and the lack of a commonality between the users 105 and 135. The message prioritization engine 145 can consider current situational factors to adjust priority weights attributable to different commonalities discovered by the determiner 142.

As used herein, presented data stores, including store 150, can be a physical or virtual storage space configured to store digital information. Data store 150 can be physically implemented within any type of hardware including, but not limited to, a magnetic disk, an optical disk, a semiconductor memory, a digitally encoded plastic memory, a holographic memory, or any other recording medium. The data store 150 can be a stand-alone storage unit as well as a storage unit formed from a plurality of physical devices. Additionally, information can be stored within data store 150 in a variety of manners. For example, information can be stored within a database structure or can be stored within one or more files of a file storage system, where each file may or may not be indexed for information searching purposes. Further, data store 150 can utilize one or more encryption mechanisms to protect stored information from unauthorized access.

Network 120 can include any hardware/software/firmware necessary to convey data encoded within carrier waves. Data can be contained within analog or digital signals and conveyed though data or voice channels. Network 120 can include local components and data pathways necessary for communications to be exchanged among computing device components and between integrated device components and peripheral devices. Network 120 can also include network equipment, such as routers, data lines, hubs, and intermediary servers which together form a data network, such as the Internet. Network 120 can also include circuit-based communication components and mobile communication components, such as telephony switches, modems, cellular communication towers, and the like. Network 120 can include line based and/or wireless communication pathways.

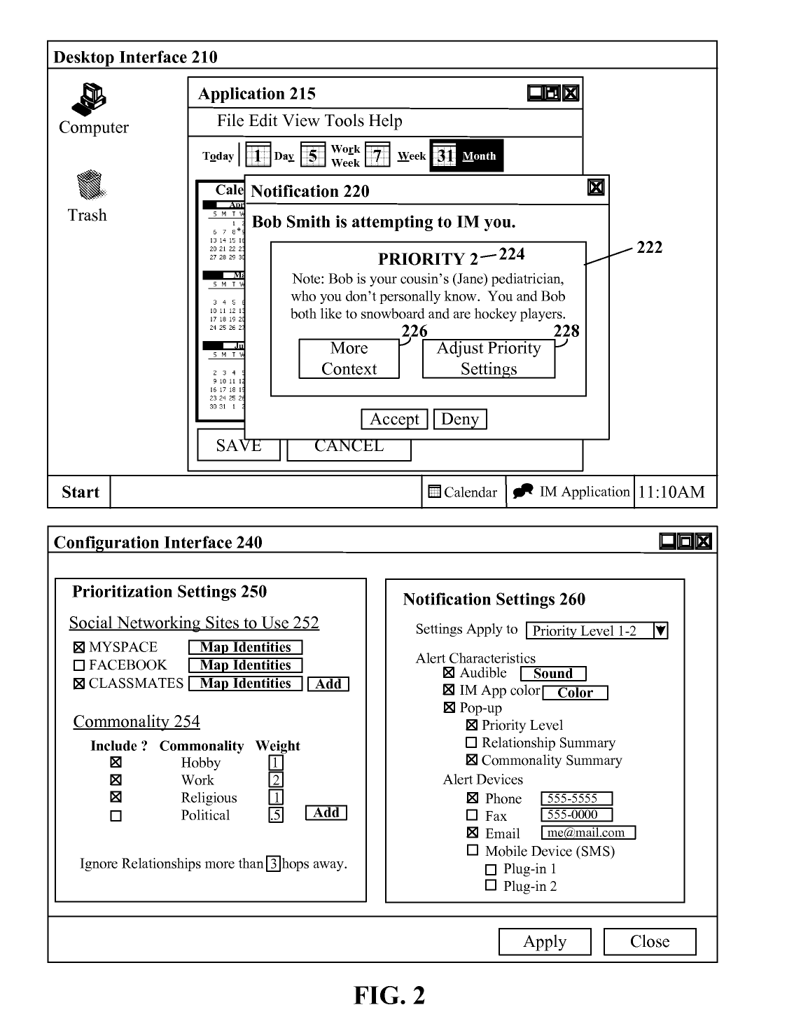

FIG. 2 shows a sample interface 210 for a system that presents IM attempt notifications based upon relationships and/or commonalities existing between communicators. In one embodiment, the relationships and/or commonalities can be based upon social networking interactions. The sample interface 210 can represent one example of an interface presented within client 125 of FIG. 1.

Interface 210 is presented for illustrative purposes only and the invention is not to be construed as limited to specific implementation details shown therein. For example, although interface 210 is a desktop graphical user interface (GUI), in other implementations a Voice User Interface (VUI), a multimodal interface, a mobile device GUI, and the like can be substitute for interface 210. An audible notification can be used in place of and/or in addition to the notice 220. Further, details contained in the notification 220 can vary from implementation-to-implementation, so long as the notification 220 is capable of indicating a relative importance of an IM communication attempt.

As shown, user of a desktop interface 210 can be utilizing a calendar application 215, when an IM communication attempt is detected. A pop-up notification 220 can be presented automatically and can receive focus (i.e., notification 220 can be placed on top of application 215 within interface 210). The notification 220 can indicate a name of an IM initiator, a priority 224 of the IM communication, and other information 222. For example, the notification can indicate a relationship between an IM initiator and the IM receiver, social networking intermediaries if any important to the indicated relationship, commonalities between the initiator and recipient, and the like. Information pertaining to relationships and commonalities can be based at least in part upon data obtained from one or more social networking sites. In one embodiment, an initial summary can be presented in notice 220, which includes links or other options 226 for obtaining more detailed information. Notice 220 can also include an option to adjust priority settings 228 used to determine the presented priority 224 levels.

Interface 240 of FIG. 2 shows a sample configuration interface, which appears upon selection to adjust priority settings 228. Specifics of interface 240 are for illustrative purposes only and a scope of the invention is not to be limited based upon specifics shown therein.

Interface 240 can permit a user to configure prioritization settings 250 used to calculate a priority value 224 and to configure notification settings 260. The prioritization settings 250 can specify which social networking sites 252 data is to be extracted from. For each site, an option to map social networking identities to IM identities can be included, as different user names can be used. A user can also select a set of commonalities 254 to be considered when calculating a priority level. Each commonality can have a user established weight. For example, a commonality (e.g., hobby related) having a weight of one can be half as important in calculating a priority compared to a different commonality (e.g., work related) having a weight of two. Other settings can be user configured, such as defining a maximum number of hops in a social networking graph permitted before a relationship is to be ignored.

Notification settings 260 can be separately configured for different priority levels, so that different notification actions can be taken depending upon a calculated priority level of an incoming IM communication. Alert characteristics, such as sounding an audible tone, setting different colors, and presenting a pop-up can be configured. Within a pop-up or other information presentation screen, a user can also configure what type of information is to be presented, such as whether priority level, a relationship summary, and/or a commonality summary is to be presented within the notification. In one embodiment, a number of devices can be established to be alerted when an IM attempt is made. For example, a notification can be set to convey an IM communication attempt notification to a phone, fax machine, email address, or mobile device, which may occur only after an IM attempt has not been responded to after an established delay (e.g., 20 seconds, a minute, fifteen minutes, etc.).

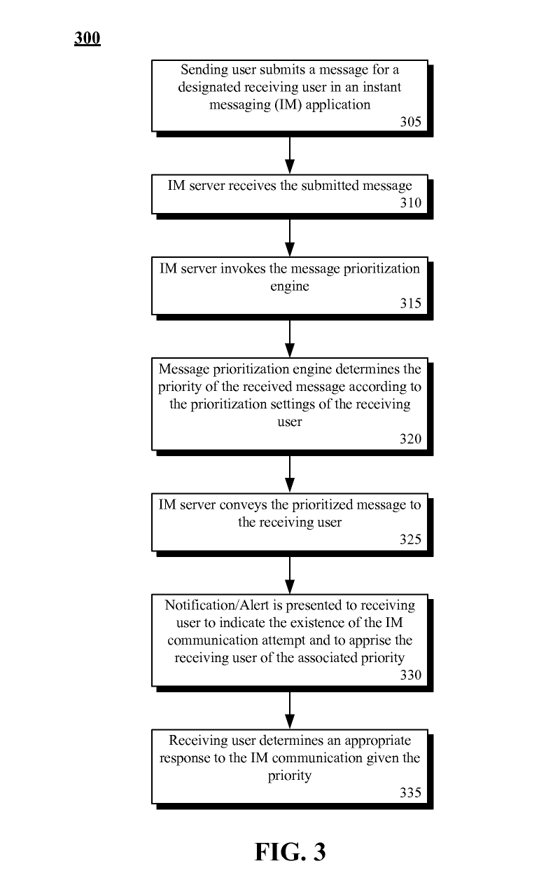

FIG. 3 is a flow chart of a method 300 for determining a relationship between an IM sender and an IM receiver and for presenting different notifications to the IM receiver indicative of a relative importance of an incoming IM communication. The method 300 can be performed in a context of system 100 or any other system supporting the prioritization of IM message delivery and supporting a presentation of different notifications based upon an IM priority.

Method 300 can begin with step 305 where a sending user can use an IM application to submit an IM message for a designated receiving user. In step 310, the IM server can receive the submitted IM message. The IM server can invoke the message prioritization engine in step 315. In step 320, the message prioritization engine can determine the priority of the received message according to the prioritization settings of the receiving user, a commonality between the communicators, a context of the message, and the like. In one embodiment, the context and the commonality can be determined based in part upon data obtained from one or more social networking systems. The IM server can then convey the prioritized message to the receiving user, as shown by step 325. In step 330, a notification and/or alert can be presented to a receiving user to indicate the existence of the IM communication attempt and to apprise the receiving user of the associated priority. In step 335, the receiving user can determine an appropriate response to the IM communication given the presented priority. For example, the user can ignore the IM communication attempt or can immediately respond to the IM communication attempt.

The flowchart and block diagrams in FIG. 3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An instant messaging (IM) system that prioritizes messages comprising:
a data store comprising information describing relationships among people and comprising recipient configurable IM prioritizing information;
a message prioritization engine configured to determine a priority value for IM communications based upon the relationships and recipient configurable IM prioritizing information of the data store; and
a client-side IM application configured to receive IM messages that have an associated priority value established by the message prioritization engine, wherein said client-side IM application is configured to present an indicator of priority value associated with received IM messages within a user interface.

2. The system of claim 1, wherein the information describing relationships is acquired from at least one social networking system.

3. The system of claim 1, wherein the information describing relationships comprises commonality conditions among said people, wherein said commonality conditions are based upon data of at least one social networking system to which said people belong.

4. The system of claim 1, further comprising:
a notification configuration interface configured to permit a user of the client-side IM application to establish settings that alter a manner in which the indicator is presented which varies depending upon the priority value.

5. The system of claim 1, wherein said recipient configurable IM prioritizing information comprises at least one setting through which a recipient defines at least one of a priority level and a priority weight that is to be assigned by the message prioritization engine to an IM communication from one of said people given a relationship condition between one of said people and said recipient, wherein said relationship condition is determined from the information describing relationships of the data store.

6. The system of claim 1, wherein said message prioritization engine is a server-side software engine whose execution is controlled by an IM server configured to facilitate IM communications among said people.

7. The system of claim 6, wherein the message prioritization engine is communicatively linked to a data store used by at least one social networking system, wherein the IM server is configured to repetitively receive updates from each social networking system, said received updates relating to at least two of said people that interact with said social networking system, wherein said received updates result in changes being automatically made to said information describing relationships.

8. The system of claim 1, wherein said indicator of the priority value comprises a notification, said notification specifying at least one of a relationship between the people as determined from social networking system obtained data and at least one commonality between the people as determined from the social networking system obtained data.

9. The system of claim 1, wherein said IM communications comprise at least one of a chat communication involving a plurality of people and a text messaging communication involving at least one mobile communication device.

10. The system of claim 1, wherein said IM communications comprise at least one of an exchange of text in real-time between at least two of said people, an exchange of Voice Over Internet Protocol (VOIP) speech between at least two of said people, a conveyance of a data file between at least two of said people, and a conveyance of video between at least two of said people.

11. A method for prioritizing Instant Messaging (IM) communications comprising:
receiving an IM communication initiating message from a sender directed to a recipient;
determining a relationship between the sender and recipient;
calculating a priority value for the IM communication initiating message based upon the determined relationship; and
conveying the priority value to the recipient along with the IM communication initiating message.

12. The method of claim 11, wherein said determined relationship is based upon interactions that said sender and said receiver have with at least one social networking system.

13. The method of claim 12, further comprising:
repetitively receiving updates from said social networking system pertaining to interactions involving at least one of the sender and receiver and the social networking system, wherein said received updates results in different values for the priority value for IM communication attempts involving the sender and the recipient that are received after the updates have been received.

14. The method of claim 11, wherein determining said relationship between the sender and the receiver is based at least in part upon commonality conditions between the sender and the recipient, wherein said commonality conditions are determined from data from a social networking system.

15. The method of claim 11, further comprising:
ascertaining previously stored recipient established priority settings; and
applying the priority settings when calculating the priority values.

16. The method of claim 11, wherein a variable notice is presented to the recipient depending upon the priority value, wherein said variable notice indicates a relative importance of the IM communication initiating message to the recipient.

17. The method of claim 11, further comprising:
a user interface of an IM application used by the recipient presenting an indication of the priority value along with a presentation of the IM communication initiating message.

18. The method of claim 11, wherein the IM communication involves a real time communication among a plurality of people, which includes said sender and said recipient;
determining a second relationship between at least one of the plurality of people and the recipient, wherein said person involved in the second relationship is not said sender; and
calculating the priority value based at least in part upon the determined second relationship.

19. A method for ascertaining an importance of incoming Instant Messaging IM communications comprising:
receiving an incoming IM communication; and
presenting a notification to a recipient of the incoming IM communication, which indicates a relative priority of the incoming IM communication, wherein said relative priority is calculated based upon at least one of a relationship between the recipient and an initiator of the incoming IM communication and at least one determined commonalities existing between the initiator and the recipient, wherein at least one of the relationship and the determined commonalities is based upon data acquired from at least one social networking system.

20. The method of claim 19, wherein said presented notification comprises text indicating at least one of the relationship and the determined commonalities.
